(19) United States
(12) Patent Application Publication
(10) Pub. No.: US 2023/0255260 A1
(43) Pub. Date: Aug. 17, 2023

(54) EDIBLE MOUTHPIECE SYSTEM FOR USE WITH SMOKABLE ITEMS

(71) Applicant: Jawid Wahidi, Irvine, CA (US)

(72) Inventor: Jawid Wahidi, Irvine, CA (US)

(73) Assignee: AIDEMAR GROUP, INC., VERNON, CA (US)

(21) Appl. No.: 17/672,326

(22) Filed: Feb. 15, 2022

(51) Int. Cl. A24D 3/18; A23G 3/50; A23G 4/18; A24F 7/00

(52) U.S. Cl. CPC A24D 3/18; A23G 3/50; A23G 4/18; A24F 7/00

(57) ABSTRACT

An edible mouthpiece system for use with a smokable item (e.g., a cigar, a cigarette, a pre-roll cone, an empty cone, a pre-rolled or hand-rolled cigarette, etc.) is provided. The edible mouthpiece may generally comprise candy (e.g., hard candy, chewing gum, etc.), or other types of edible materials. During use, the edible mouthpiece is coupled with the mouth end of a smokable item, comes into physical contact with the user's mouth, and provides flavoring thereto to enhance the smoking experience. Smoke from the smokable item also may be enhanced with flavor while passing through an inner passageway within the mouthpiece to the user's mouth.

### FIELD OF THE INVENTION

The present invention relates to smokable items, including an edible mouthpiece for use with cigars, cigarettes, pre-rolls, and other smokable items.

### BACKGROUND

Cigars are well known and smoked for pleasure throughout the world. Cigar mouthpieces (also referred to as cigar tips) are mouthpieces designed to be coupled to the mouth end of a cigar (e.g., the end that is pressed against one's lips for smoking) to provide one or more surfaces for the user to hold the mouthpiece with his/her mouth (e.g., lips, teeth, etc.).

Currently, cigar mouthpieces are formed of plastic and thereby add no flavoring to the cigar during the smoking experience.

Accordingly, there is a need for an edible cigar mouthpiece for use with cigars and that add flavoring to the cigar to maximize the user's smoking experience.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the sev-eral views, and wherein:

FIG. 1 shows a schematic of an edible mouthpiece system according to exemplary embodiments hereof;

FIG. 2 shows a side sectional view of the edible mouthpiece system of FIG. 1 according to exemplary embodiments hereof;

FIGS. 3-4 show end views of the edible mouthpiece system of FIG. 1 according to exemplary embodiments hereof;

FIG. 5 shows an edible mouthpiece system coupled with a smokable item according to exemplary embodiments hereof;

FIG. 6 shows a side sectional view of an edible mouthpiece system according to exemplary embodiments hereof;

FIG. 7 shows an edible mouthpiece system coupled with a smokable item according to exemplary embodiments hereof;

FIG. 8 shows a side sectional view of an edible mouthpiece system according to exemplary embodiments hereof; and

FIG. 9 shows an edible mouthpiece system coupled with a smokable item according to exemplary embodiments hereof.

### DETAILED DESCRIPTION OF THE INVENTION

For the purposes of this specification, the terms below will mean the following.

Cigar generally refers to a smokable comprising a rolled bundle of dried and fermented tobacco leaves. Cigars typically include three distinct components: the filler, the binder leaf which holds the filler together, and a wrapper leaf to form the smokable.

Cigarette generally refers to a smokable comprising a thin cylinder of finely cut tobacco, cannabis, other types of leaves, flowers, herbs, and/or other smokable materials, rolled in a suitable paper for smoking.

Cone generally refers to a conical- or frustum-shaped cigarette (or “joint”) wherein the shape flares from a smaller diameter proximal base to a larger diameter distal tip. Cones may typically comprise paper, hemp, palm leaves, rice, cotton cellulose, glycerin, and/or other suitable materials.

Pre-roll generally refers to a cigarette or cone that has been formed prior to its sale and is therefore consumer-ready (i.e., a consumer is not required to fill or otherwise form the smokable).

Empty cone refers to an empty cone into which a consumer may place smokable materials (e.g., tobacco, cannabis, etc.) to form a smokable cone.

Mouthpiece refers to a tip coupled with the mouth end of a cigar, cone, cigarette, or other smokable item that acts to support the proximal end of the smokable (e.g., the end that is pressed against one's lips for smoking) and to provide one or more surfaces for the user to hold the mouthpiece with his/her mouth (e.g., lips, teeth, etc.).

In general, and according to exemplary embodiments hereof, an edible mouthpiece system 10 for use with a smokable item (e.g., a cigar, a cigarette, a pre-roll cone, an empty cone, a pre-rolled or hand-rolled cigarette, etc.) is provided. The edible mouthpiece system 10 may generally comprise candy (e.g., hard candy, chewing gum, etc.), other types of edible materials, and any combinations thereof. During use, the edible mouthpiece system 10 is coupled with the mouth end of a smokable item, comes into physical contact with the user's mouth, and provides flavoring thereto to enhance the smoking experience. Smoke from the smokable item also may be enhanced with flavor while passing through an inner passageway within the mouthpiece system 10 to the user's mouth.

In some embodiments, the edible mouthpiece system 10 is provided as a standalone item for use in pre-rolling and/or hand rolling a cigar, cone, cigarette, etc. In other embodiments, the edible mouthpiece system 10 includes (e.g., is coupled with) an empty cone and is provided to the consumer. The consumer then may fill the empty cone with smokable materials to form a smokable cone wherein the edible mouthpiece system 10 is used as the cone's mouthpiece. It is understood that the edible mouthpiece system 10 may be used with any suitable smokable item in any suitable configuration and that the examples provided herein are not meant to be limiting.

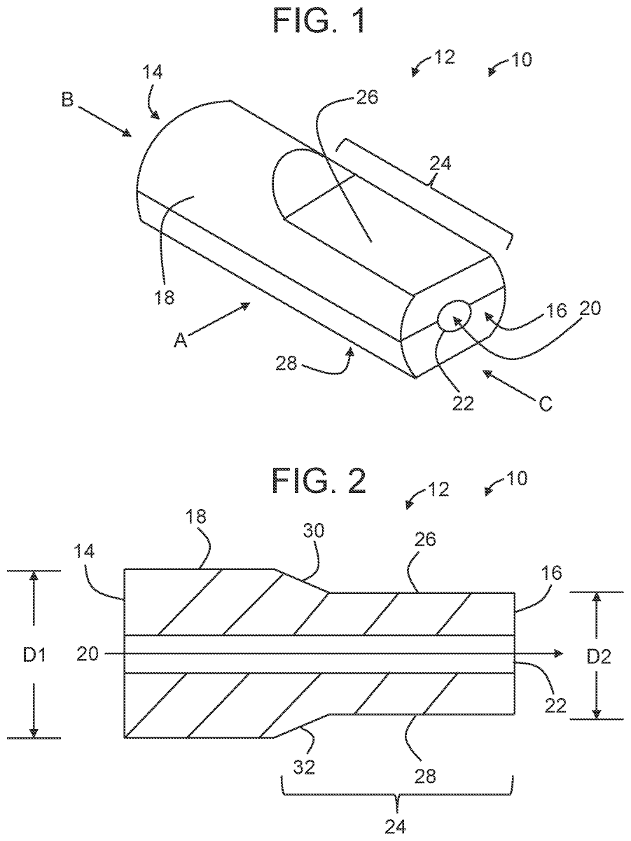

In one exemplary embodiment hereof as shown in FIG. 1, the edible mouthpiece system 10 includes a mouthpiece body 12 including a first end 14 (e.g., a proximal end to be joined with a smokable item such as a cigar), a second end 16 (e.g., a distal end to be placed against a user's mouth for smoking), and sidewalls 18 extending between the first end 14 and the second end 16. The system 10 also includes an inner passageway 20 passing through the body 12 from the first end 14 to the second end 16. The opening 22 in the second end 16 communicates with the inner passageway 20 and serves as an opening through which the user may inhale smoke while using the system 10.

In some embodiments, the system 10 also includes a mouth portion 24 including an upper mouth surface 26 and a lower mouth surface 28 that may provide areas onto which the user may place his/her teeth and/or lips to generally hold the system 10 within his/her mouth during use. The insert system 10 also may include other elements as necessary for the system 10 to perform its functionalities.

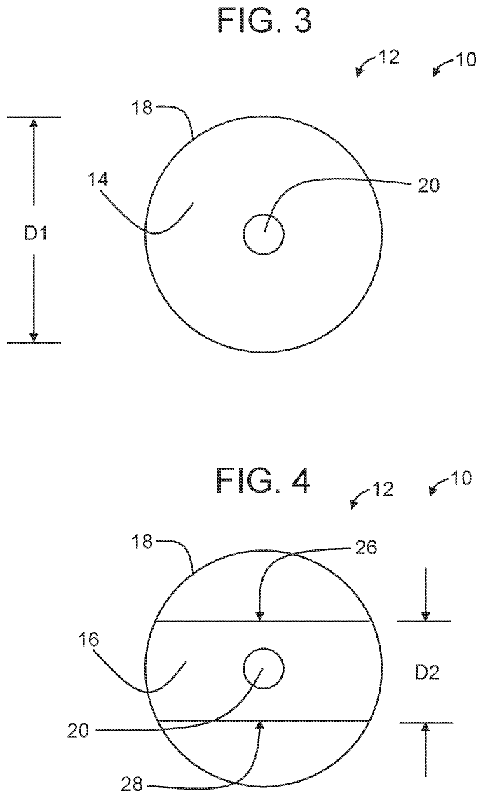

The edible mouthpiece system 10 will next be described in further detail with respect to FIGS. 1-9. FIGS. 2 and 5-6 show side sectional views of various embodiments of the system 10 taken from the perspective of the arrow A in FIG. 1. FIG. 3 shows the embodiment of FIG. 1 taken from the perspective of the arrow B in FIG. 1, and FIG. 4 shows the embodiment taken from the perspective of the arrow C.

In some embodiments, as shown in FIG. 3, the mouthpiece body 12 includes a generally circular cross-sectional shape. However, it is understood that the body 12 may include other cross-sectional shapes such as, without limitation, oval, square, trapezoidal, polygonal, other suitable shapes, and any combinations thereof.

In some embodiments, as shown in FIGS. 3-4, the inner passageway 20 includes a generally circular cross-section (although other shaped cross-sections also may be used, such as, e.g., oval, or square) and is generally centered in the cross-section of the mouthpiece body 12. However, it is understood that the inner passageway 20 may be offset from the middle of the cross-section as desired. It also is contemplated that the system 10 may include two or more inner passageways 20. In this case, the plurality of inner passageways 20 may be generally parallel with one another and/or at offset angles. Because smoke traveling through the inner passageway(s) 20 may be infused with flavoring released from the sidewalls of the inner passageway(s) 20, additional inner passageways 20 may increase the surface areas in contact with the smoke and therefore provide a higher amount of flavoring to be released into the smoke. The diameter of the inner passageway(s) 20 may be chosen to provide a desirable draw of the smoke from the first end 14 to the second end 16 of the mouthpiece system 10 and a desirable amount of flavoring during use of the system 10 with a smokable item (e.g., with a cigar).

In some embodiments, as shown in FIGS. 1, 2 and 4, the mouthpiece body 12 includes a mouth portion 24 towards its second (distal) end 16. In some embodiments, the mouth portion 24 includes an area of the body 12 with a reduced size cross-section. For example, an upper portion of the body 12 may be removed to form the upper mouth surface 26, and/or a lower portion of the body 12 may be removed to form a lower mouth surface 28. In some embodiments, as shown in FIG. 2, this may reduce the height of the body 12 from D1 (towards the first (proximal) end 14) to D2 (towards the second (distal) end 16).

In some embodiments, as shown in FIG. 4, the width D1 of the body 12 may remain constant from the first end 14 to the second end 16. However, it also is contemplated that the width D1 of the body 12 towards the second end 16 also may be reduced by removing a side portion of the body 12 (e.g., an upper and/or lower portion) in these areas.

In some embodiments, as shown in FIG. 4, the upper mouth surface 26 and the lower mouth surface 28 may be generally parallel with one another, but this may not be necessary. The height D2 of the mouth portion 24 may be chosen such that the mouth portion 24 fits comfortably between the user's lips and/or teeth during use. In some embodiments, as shown in FIG. 2, the mouth portion 24 may include an upper transitional surface 30 that generally transitions from the upper mouth surface 26 to the sidewalls 18 towards the first end 14 of the body 12, and a lower transitional surface 32 that generally transitions from the lower mouth surface 28 to the sidewalls 18 towards the first end 14. While the transitional surfaces 30, 32 are depicted as generally linear, it is understood that the surfaces 30, 32 may include concave and/or convex curvatures.

In some embodiments, the first end 14 of the mouthpiece body 12 is adapted to be abutted against and coupled to an unlit mouth end of a smokable item SI such as a cigar. In some embodiments, an outer layer of wrapping leaf, paper, or other suitable material may be wrapped circumferentially around the outer interface between the mouthpiece body 12 and the mouth end of the smokable item SI to form a seal between the two 12, SI. In this embodiment, it may be preferable that D1 of the mouthpiece body 12 be chosen to generally match the diameter of the mouth end of the smokable item SI so that the outer sidewalls 18 of the mouthpiece body 12 and the outer sidewalls of the smokable item SI are generally flush.

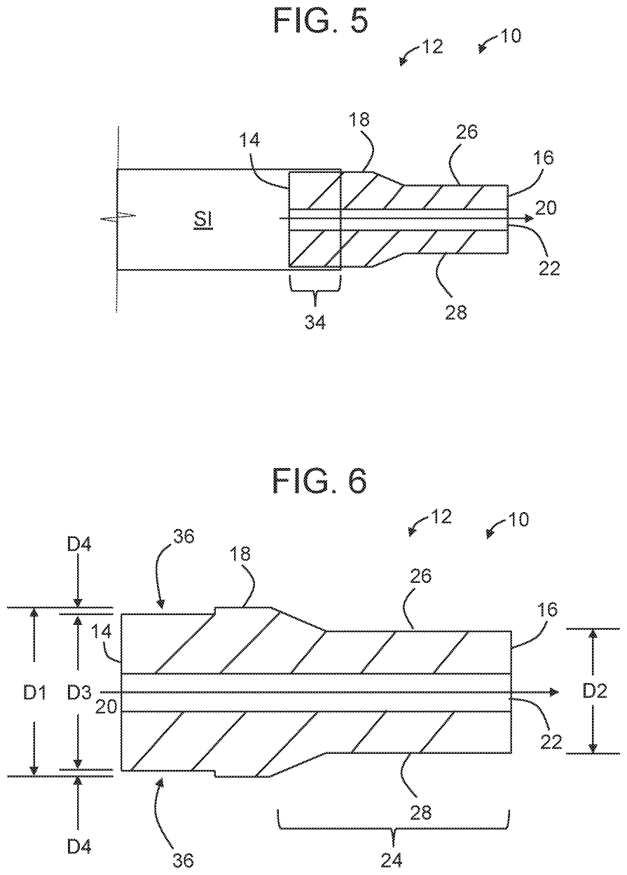

In some embodiments, as shown in FIG. 5, the unlit mouth end of the smokable item SI may be hollowed out forming a hollow portion 34 (encircled by the smokable item's outer circumferential material) into which the first end 14 of the system 10 may be placed and attached. In some embodiments, a portion of the mouthpiece body 12 towards the first end 14 is received into the hollow portion 32 and adhered therein using pressure fit, glue, or other attachment techniques between the first end 14 and the inner surfaces of the hollow portion 34. In some embodiments, an outer layer of wrapping leaf, paper, or other suitable material may be wrapped circumferentially around the outer interface between the mouthpiece body 12 and the hollow portion 34 of the smokable item SI to form a seal between the two 12, 34.

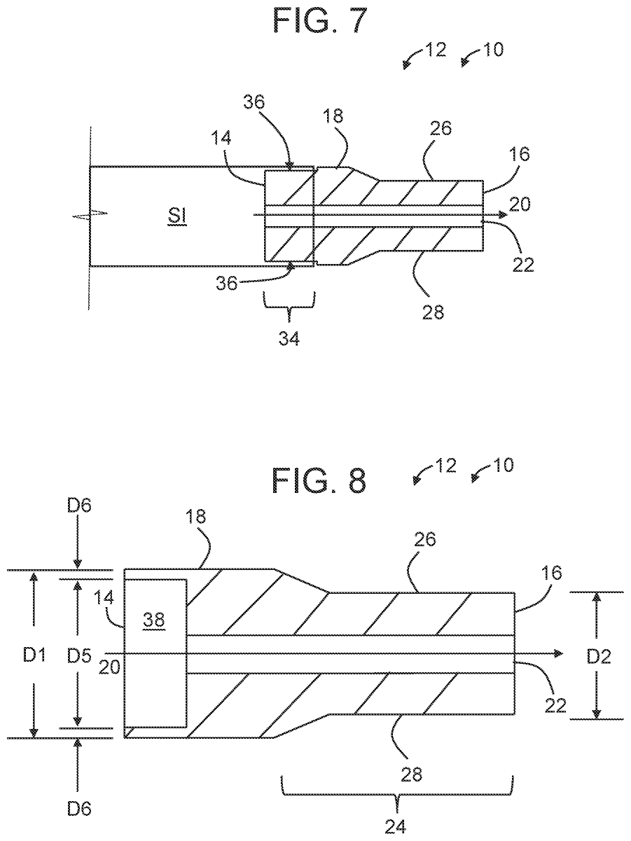

In some embodiments, as shown in FIG. 6, the sidewalls 18 about a portion of the mouthpiece body 12 towards the first end 14 include an outer circumferential notch 36 (with depth D4) adapted to receive the outer circumferential wrapping of the smokable item's hollow portion 34. In this way, as shown in FIG. 7, with the first end 14 portion of the mouthpiece body 12 with diameter D3 received into the hollow portion 34, the outer circumferential wrapping about the hollow portion 34 received within the notch 36 may be generally flush with the mouthpiece body's sidewalls 18. The first end 14 portion may then be adhered within the hollow portion 34 using pressure fit, glue, or other attachment techniques. In some embodiments, an outer layer of wrapping leaf, paper, or other suitable material may be wrapped circumferentially around the outer interface between the mouthpiece body 12 and the hollow portion 34 of the smokable item SI to form a seal between the two 12, 34.

In some embodiments, as shown in FIG. 8, the first end 14 of the mouthpiece body 12 includes an end cavity 38 adapted to receive the mouth end of a smokable item SI (e.g., cigar). In this embodiment, it may be preferable that the smokable item SI does not include a hollow portion 34. The cross-sectional shape of the end cavity 38 may be circular to match the cross-sectional shape of the smokable item SI but other cross-sectional shapes also may be used.

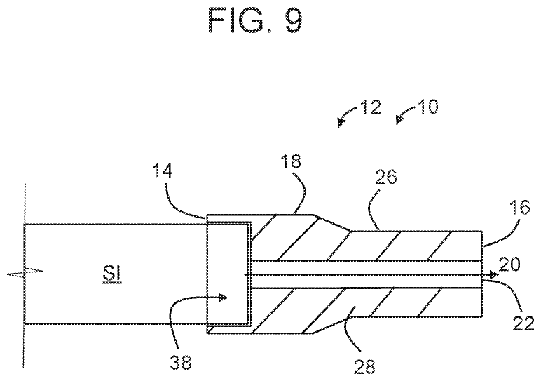

In some embodiments, the end cavity 38 includes a diameter D5 chosen to generally match the diameter of the mouth end of the smokable item SI so that the mouth end of the smokable item SI may be inserted into the end cavity 38 and be held securely therein. This is shown in FIG. 9.

In some embodiments, as shown in FIG. 8, the sidewalls 18 immediately adjacent and generally defining the end cavity 38 have a thickness of D6 (e.g., about 0.0625″-0.25″) and a length sufficient to extend over a portion of the mouth end of the smokable item SI such that the mouth end may be held snugly therein (e.g., about 0.25″-1.0″ and preferably about 0.5″). The mouth end may be secured within the end cavity 38 using pressure fit, adhesive, other securing techniques, and any combinations thereof. In some embodiments, an outer layer of wrapping leaf, paper, or other suitable material may be wrapped circumferentially around the outer interface between the mouthpiece body 12 and the smokable item SI to form a seal between the two 12, SI.

In some embodiments, the mouthpiece body 12 comprises an edible material. For example, the body 12 may comprise any type of hard sugar candy, compressed sugar candy, caramel, butterscotch, chewing gum, bubble gum, sucker, jaw breaker, chocolate, taffy, toffee, marzipan, praline, marshmallow, candy cane, mint, gumdrop, gummy, other types of edible materials, and any combinations thereof. It is understood that the edible material may include any type of flavoring as desired, such as, without limitation, fruit flavored (e.g., cherry, grape, lemon-lime, raspberry, mango, coconut, banana, orange, apple, lemonade, limeade, etc.), mint, chocolate, vanilla, caramel, sour, other flavors, and any combinations thereof.

In some embodiments, the edible material is chosen to have a melting point that enables the mouthpiece body 12 to generally hold its form without completely melting during use. It is understood that the edible material may be affected by the temperature of the smoke from the burning smokable item SI, and that the temperature may cause the edible material to slightly melt or otherwise warp during use. However, it is preferable that the edible material be designed to generally withstand bursts of high temperature smoke from the smokable item SI being inhaled by the user and to not completely lose its shape and form during the duration of the smoking experience (e.g., 5-15 minutes). For example, it may be preferable that the edible material be able to withstand 3-5 second bursts of 400° C.-900° C. smoke without significantly deforming (e.g., without the inner passageway 20 closing and/or becoming obstructed).

In some implementations, e.g., the mouthpiece system 10 may be provided to manufacturers of cigars, cigarettes, pre-roll cones, and/or empty cones, etc. to be coupled to these types of products and then sold to consumers. In another example, the mouthpiece system 10 may be coupled with a cigar, pre-roll cone and/or cigarette, and/or to an empty cone during its manufacturing and made for sale to consumers as the combination. In another example, the mouthpiece system 10 may be sold directly to consumers such that the consumers themselves may couple the mouthpiece system 10 with wrapper leaf, rolling paper, or other materials to form a cigar, cigarette, a cone, an empty cone, or other type of smokable item. It is understood that the examples described above are meant for demonstration and are non-limiting.

It is understood that any details and/or aspects of any embodiments described herein may be combined with any details and/or aspects of any other embodiments in any way to form additional embodiment(s) all of which are within the scope of the filter system 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A mouthpiece for use in receiving smoke from a smokable item and delivering the smoke to a user's mouth, the mouthpiece comprising:
a mouthpiece first end, a mouthpiece second end, and mouthpiece sidewalls extending between the mouthpiece first end and the mouthpiece second end, the mouthpiece comprised entirely of edible materials; and
an inner passageway defined by passageway sidewalls comprised of the edible materials and extending through the mouthpiece from the mouthpiece first end to the mouthpiece second end;
wherein the smokable item includes a smokable downstream end comprising smokable materials;
wherein the mouthpiece second end is coupled directly to the smokable downstream end of the smokable item, and the mouthpiece first end includes at least one surface for contacting a user's mouth;
wherein in use, the smoke contacts the passageway sidewalls.

2. The mouthpiece of claim 1 wherein the edible materials include at least one of candy, chewing gum, and gummy.

3. The mouthpiece of claim 1 wherein the at least one surface includes an upper surface and a lower surface, the upper and lower surfaces being parallel with one another.

4. (canceled)

5. The mouthpiece of claim 1 wherein the mouthpiece second end includes a diameter that substantially matches a diameter of the smokable proximal end of the smokable item.

6. The mouthpiece of claim 1 wherein a height of the mouthpiece second end is greater than a height of the mouthpiece first end.

7. (canceled)

8. The mouthpiece system of claim 1 wherein the first end includes a first end cavity adapted to receive a portion of the mouth end of the smokable item.

9. The mouthpiece of claim 1 wherein the mouthpiece is secured to the smokable proximal end of the smokable item using at least one of adhesive, pressure fit, and wrapping material.

10. The mouthpiece system of claim 1 wherein the at least one inner passageway includes two or more inner passageways.

11. The mouthpiece system of claim 10 wherein the two or more inner passageways are parallel with one another.

12. The mouthpiece of claim 1 wherein the edible material is chosen to withstand 3-5 second bursts of 400° C.-900° C. smoke without the inner passageway closing and/or becoming obstructed.

13. (canceled)

14. (canceled)

15. A smokable assembly comprising:
a mouthpiece comprised entirely of edible materials, the mouthpiece including a mouthpiece first end, a mouthpiece second end, a mouthpiece body extending between the mouthpiece first end and the mouthpiece second end, and a passageway defined by passageway sidewalls comprised of the edible materials and extending through the mouthpiece body from the mouthpiece first end to the mouthpiece second end; and
a smokable member comprised entirely of smokable materials, the smokable member including a member first end, a member second end, and a member body extending between the member first end and the member second end;
wherein the mouthpiece second end is coupled directly to the member first end, and wherein in use, smoke from the smokable member passes through the passageway and contacts the passageway sidewalls.

16. The smokable assembly of claim 15 wherein the member second end is unobstructed and adapted to be combusted.

17. The smokable assembly of claim 15 wherein the member first end includes outer circumferential material that overlaps at least a portion of the mouthpiece second end and wherein the outer circumferential material includes paper and/or plant-based materials.

18. The smokable assembly of claim 15 wherein the smokable materials include paper and/or plant-based materials.

19. The smokable assembly of claim 18 wherein the plant-based materials include tobacco and/or cannabis.

20. The smokable assembly of claim 15 wherein the smokable member includes at least one selected from the group: cigar, cigarette, empty cone, and pre-roll.

21. A smokable assembly consisting essentially of:
a mouthpiece comprised entirely of edible materials, the mouthpiece including a mouthpiece first end, a mouthpiece second end, a mouthpiece body extending between the mouthpiece first end and the mouthpiece second end, and a passageway defined by passageway sidewalls comprised of the edible materials and extending through the mouthpiece body from the mouthpiece first end to the mouthpiece second end; and
a smokable member comprised entirely of smokable materials, the smokable member including a member first end, a member second end, and a member body extending between the member first end and the member second end;
wherein the mouthpiece second end is coupled directly to the member first end, and wherein in use, smoke from the smokable member passes through the passageway and contacts the passageway sidewalls.

22. A smokable assembly consisting essentially of:
a mouthpiece comprised entirely of edible materials, the mouthpiece including a mouthpiece first end, a mouthpiece second end, a mouthpiece body extending between the mouthpiece first end and the mouthpiece second end, and a passageway extending through the mouthpiece body from the mouthpiece first end to the mouthpiece second end; and
a smokable member comprised entirely of smokable materials, the smokable member including a member first end, a member second end, and a member body extending between the member first end and the member second end;
wherein the mouthpiece second end is coupled directly to the member first end;
wherein the member first end includes outer circumferential wrapping paper that overlaps and is bonded directly to at least a portion of the mouthpiece second end.

23. The smokable assembly of claim 22 wherein the outer circumferential wrapping paper includes paper and/or hemp.

24. The mouthpiece of claim 1 wherein the smokable proximal end of the smokable item includes outer circumferential wrapping paper that overlaps and is bonded directly to at least a portion of the mouthpiece second end.
